(19) United States
(12) Patent Application Publication
(10) Pub. No.: US 2003/0074365 A1
(43) Pub. Date: Apr. 17, 2003

(54) Checking address data being entered in personal information management software

(76) Inventor: Randy P. Stanley, Aptos, CA (US)

Correspondence Address: Timothy N. Trop, TROP, PRUNER & HU, P.C., STE 100, 8554 KATY FWY, HOUSTON, TX, 77024-1805, US

(21) Appl. No.: 09/981,229

(22) Filed: Oct. 17, 2001

(51) Int. Cl. G06F 17/00

(52) U.S. Cl. 707/102

(57) ABSTRACT

Checker software may be utilized to automatically check data intended to be stored in association with personal information management software. A variety of independent databases may be checked including databases resident on a particular processor-based system that also stores the personal information management software. In addition, databases resident on connected networks may be checked, as may databases accessible through web sites on the Internet. As a result, the integrity of data stored in association with personal information management software may be improved.

### BACKGROUND

This invention relates generally to information management software, which has geographical context, including software providing addresses, phone numbers, schedules, and the like.

For example, many people maintain personal information management software on their computers to improve their personal efficiency. This software may be useful in scheduling meetings and finding addresses and phone numbers in order to make contact with people.

Of course, any database is only as good as the information contained in the database. Thus, a user may copy information off a letter, for example, and mis-enter the data in the personal information software database. Then, if the user can no longer find the letter, the personal information management software is rendered largely useless. Additionally, information may change over time, for instance an area code or ZIP code may sub-divide.

Therefore, it would be desirable to have a way to continually validate the integrity of the data entered in association with personal information management software.

### BRIEF DESCRIPTION OF THE DRAWINGS

FIG. 1 is a schematic depiction of one embodiment of the present invention;

FIG. 2 is a schematic depiction of a processor-based system in accordance with one embodiment of the present invention; and

FIG. 3 is a flow chart for software in accordance with one embodiment of the present invention.

### DETAILED DESCRIPTION

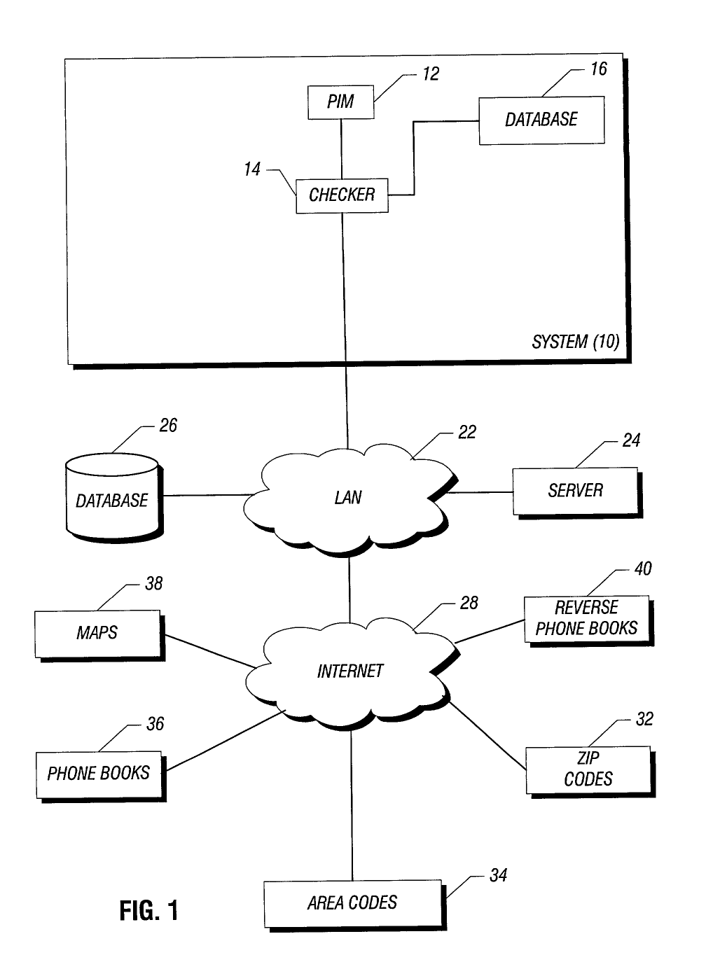

Referring to FIG. 1, a processor-based system 10 may be a personal computer, a wireless telephone, a handheld appliance or any of the large variety of processor-based systems. The system 10 may be utilized to maintain information management software 12, such as personal information management (PIM) software, in accordance with one embodiment of the present invention. The personal information management software 12 may manage calendars, schedules, and databases of addresses and phone numbers, as a few examples.

A checker software 14 may be provided to screen any data being entered through the information management software 12. In particular, the checker software 14 automatically checks address data to determine its integrity. The checker software 14 may check the data integrity by checking a database 16 on the system 10 in one embodiment.

The database 16 may have information that correlates certain address-type information with other address-type information. In one embodiment, the database 16 may be a relational database. For example, the database 16 can correlate cities to their zip codes, cities to their area codes, cities with their states, area codes with their zip codes, streets with cities, and zip codes with area codes.

Thus, with this relational information, the checker software 14 can determine whether address information being entered into the personal information management software 12 is information that is at least possibly correct. If the information is not possibly correct, the user may be notified. For example, if a zip code 77024 is no where existent in Los Angeles, the software can determine that the address “Los Angeles, California 77024” can not possibly be correct, and may even provide a possible solution.

The processor-based system 10 may be coupled through a local area network 22 to a network-wide database 26. A server 24 may serve data from the database 26 over the network 22 to networked systems, including the system 10. The database 26 may include the same kind of information as the database 16 but may include more information of the same type in one embodiment.

Similarly, the system 10 may couple, through the local area network 22, to the Internet 28. The Internet 28 may include a number of web sites that may include the same type of information as the database 16, but may include a greater quantity of information. For example, web sites 38 that have map information may be able to correlate addresses with cities. Similarly, web sites 36 with phone books may correlate names with cities and streets. Similarly, web sites 34 with a correlation between area codes, cities and zip codes may be utilized to check address information. Likewise, web sites 32 that have zip code information may provide checking functions as well. As a final example, reverse phone book web sites 40 may be utilized to determine whether a phone number actually correlates to a given address.

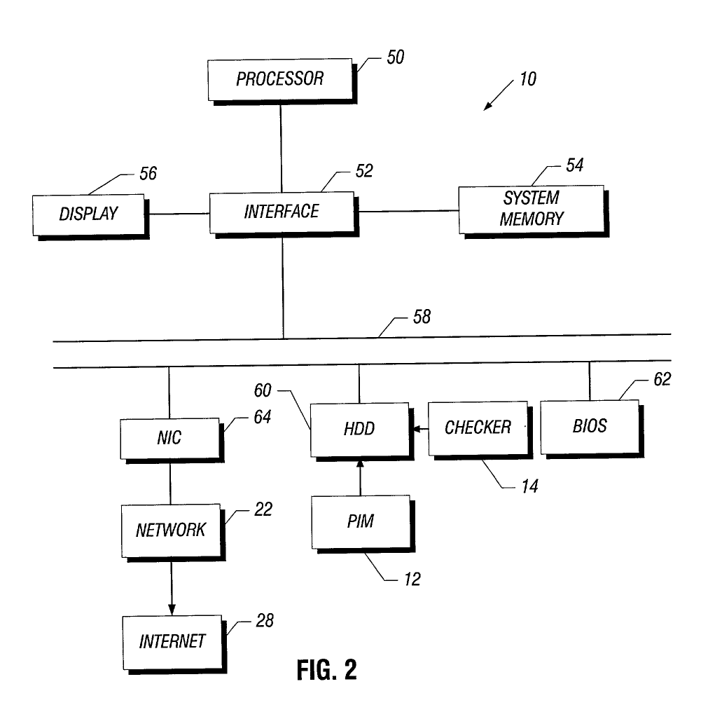

Referring to FIG. 2, the system 10 may include a processor 50 coupled to an interface 52. The interface 52 in turn may be coupled to system memory 54 and a display 56. Similarly, the interface 52 may be coupled to a bus 58. In one example, the bus 58 may couple a network interface card 64 that couples to the network 22 and ultimately to the Internet 28.

A hard disk drive 60 or other storage device may also be coupled to the bus 58 in one embodiment. The checker software 14 and the PIM software 12 may be stored on the hard disk drive 60 in one embodiment. A basic input/output system (BIOS) 62 storage may also be provided on the bus 58 in one embodiment. Of course, a variety of other hardware architectures may be utilized with embodiments of the present invention.

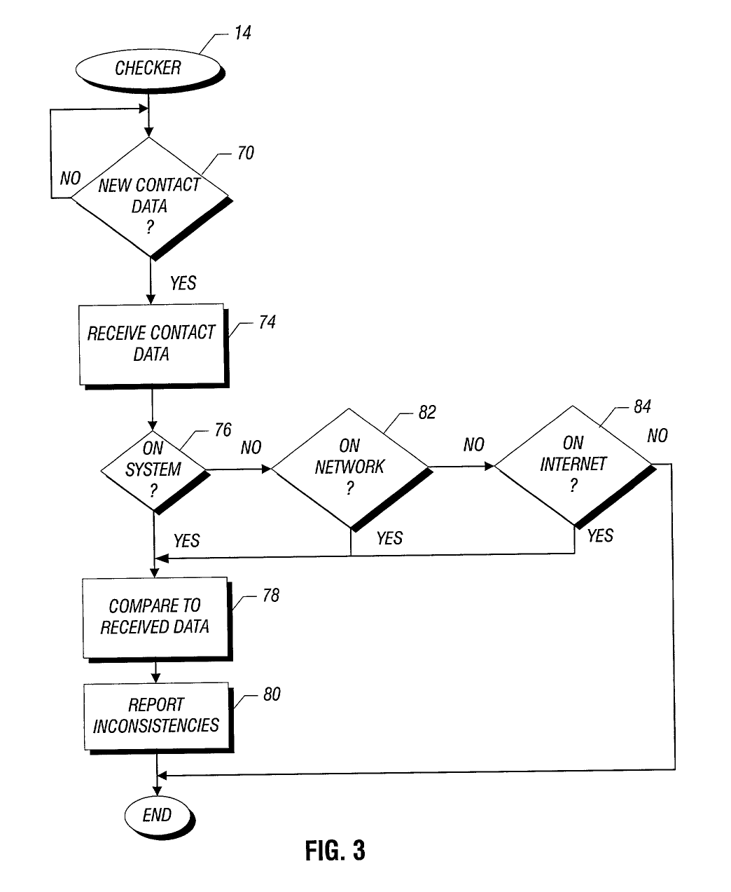

Turning finally to FIG. 3, the checker software 14 initially determines whether new contact data is destined for the storage associated with the PIM software, or any other software including a “checked” typed field. 12, as determined in diamond 70. If so, the new contact data may be received, as indicated in block 74. That contact data may include address information, a phone number or an e-mail information as a few examples. A check at diamond 76 determines whether any of the received data can be checked on the system 10, for example, using the database 16. If not, resources on the network 22, such as the database 26, may be consulted, as indicated in diamond 82. If the data is not available on the network 82, then the data can be checked on the Internet, as indicated at diamond 84. If comparison data is not available on any of these sources, the flow ends.

If comparison data is available on one or more of the system 10, network 22, or Internet 28, the comparison data may be compared to the received data, as indicated in block 78. Any inconsistencies between the data in the relevant database and the received data may be reported, as indicated in block 80. As a result, an automated process that automatically attempts to check the data using other sources may improve the integrity of data stored in association with PIM software 12.

Thus, the field within the software may indicate via an attribute that the field is of a particular type of information and relates to specified other fields should they exist (area code or ZIP may relate to a city/State/Country, etc.) and thus subject to checking of that type as it may be available. For instance, checks upon data entry may be limited to local data but later subject to a more up-to-date Internet database check (or subject to a more complete database that incurs charges). The checks may be subject to periodic review. For example, what is correct today may not be when geographies are rezoned.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving address data used with personal information management software; and
comparing the address data to data in an independent database to determine the integrity of the data.

2. The method of claim 1 including comparing the address data to data in a database on a processor-based system that also stores said personal information management software.

3. The method of claim 1 including comparing the address data with data available from a database accessible through a network.

4. The method of claim 1 including comparing the address data to data accessible through the Internet.

5. The method of claim 1 including automatically determining whether data sought to be entered into personal information management software is consistent with data stored in an independent database.

6. An article comprising a medium storing instructions that enable a processor-based system to:
receive address data used with personal information management software; and
compare the address data to data in an independent database to determine the integrity of the data.

7. The article of claim 6 further storing instructions that enable the processor-based system to compare the address data to data in a database on a processor-based system that also stores said personal information management software.

8. The article of claim 6 further storing instructions that enable the processor-based system to compare the address data with data available from a database accessible through a network.

9. The article of claim 6 further storing instructions that enable the processor-based system to compare the address data to data accessible through the Internet.

10. The article of claim 6 further storing instructions that enable the processor-based system to automatically determine whether data sought to be entered into personal information management software is consistent with data stored in an independent database.

11. A system comprising:
a processor; and
a storage coupled to said processor storing instructions that enable the processor to:
receive address data used with personal information management software; and
compare the address data to data in an independent database to determine the integrity of the data.

12. The system of claim 11 wherein said storage stores instructions that enable the processor-based system to compare the address data to data in a database on a processor-based system that also stores said personal information management software.

13. The system of claim 11 wherein said storage stores instructions that enable the processor-based system to compare the address data with data available from a database accessible through a network.

14. The system of claim 11 wherein said storage stores instructions that enable the processor-based system to compare the address data to data accessible through the Internet.

15. The system of claim 11 wherein said storage stores instructions that enable the processor-based system to automatically determine whether data sought to be entered into personal information management software is consistent with data stored in an independent database.
